(19) United States
(12) Patent Application Publication
(10) Pub. No.: US 2011/0309202 A1
(43) Pub. Date: Dec. 22, 2011

(54) Wingtec Holding Limited

(76) Inventor: John Jaycott Smith, Gloucestershire (GB)

(21) Appl. No.: 12/865,892

(22) PCT Filed: Feb. 3, 2009
(86) PCT No.: PCT/GB2009/000286

§ 371 Date: Oct. 26, 2010

(30) Foreign Application Priority Data
Feb. 4, 2008 (GB) 0802000.0

(51) Int. Cl. B64C 21/04; B64C 21/06; B64C 21/00

(52) U.S. Cl. 244/208; 244/198

(57) ABSTRACT

A control device (16) for a wing (10) comprises an airbox assembly (16) connected to an aerofoil wing tip (17). The airbox assembly (16) includes passages (23) that receive air from the lower surface of the aerofoil (10) and accelerate and exhaust the air upwardly, outwardly and rearwardly of the aerofoil (10). This reduces or prevents the formation of wing tip vortices and so reduces induced drag. In addition, the airbox assembly (16) also includes a wing tip (17) of increased camber relative to the wing (10) that changes the flow of air over the lower pressure surface (11) of the wing (10) to mirror that over the higher pressure wing surface (12) so reducing on eliminating bound trailing edge vortices. Such devices can be used on other foils that operate in fluid streams to provide a force.

The invention relates to control devices for attachment to finite wings and to finite wings including such control devices. The terms “finite wing” and “wing” are used in the specification to include wings that generate lift or equivalent forces when in any fluid stream, not limited to air.

It is known that, when a wing is placed in a fluid stream such as air, the flow of air over the aerofoil produces a relatively lower pressure on a first surface of the aerofoil and a relatively higher pressure on a second surface of the aerofoil. In an aircraft, the first surface is an upper surface of the wing and the second surface is a lower surface of the wing. This pressure differential generates lift. In many applications, such as aeroplane wings, the wing is cantilevered from a body such as an aeroplane fuselage and has an end remote from that body. As a result of the pressure differential between the higher and lower pressure surfaces of the wing, fluid from the higher pressure surface migrates to the lower pressure first surface of the wing around the end (wingtip) of the wing.

The consequence of this is that the airflow over the wing (that is, over the first and second surfaces) is modified, since the migration of the airflow over the higher pressure surface around the wingtip to the lower pressure surface results in a spanwise flow over this surface back and outboard towards the wingtip. Conversely, airflow migration from the higher pressure surface to the lower pressure surface results in the airflow over the lower pressure surface being modified to a flow in a backward and inward direction. The result of these now diverging/converging airflows, when they meet at the wing's trailing edge, is to create vortices, which have an outer boundary at the wingtips (where the vortex energy is greatest), and persist along the trailing edge of the wing in a direction away from the wingtip. The vortices lying along the wingspan are referred to as the bound vortices, whereas the vortices that are shed at the trailing edge of the wing are called free vortices and travel downstream for a considerable distance behind the aircraft before eventually joining up. These trailing vortices—the bound and the free—are in the shape of a horseshoe and are thus referred to as a horseshoe vortex.

In the publication “Theory of Wing Sections” by Abbott & von Doenhoff it is disclosed that “the effect of trailing vortices corresponding to positive lift is to induce a downward component of velocity at and behind the wing. This downward component is called downwash. The magnitude of the downwash at any section along the span (of the wing) is equal to the sum of the effects of all the trailing vortices along the entire span (of the wing). The effect of the downwash is to change the relative direction of the airstream over the section (wing). The section (wing) is assumed to have the same aerodynamic characteristics with respect to the rotated airstream as it has in normal two-dimensional flow. The rotation of the flow effectively reduces the angle of attack. Inasmuch as the downwash is proportional to the lift coefficient, the effect of the trailing vortices is to reduce the slope of the lift curve. The rotation of the flow also causes a corresponding rotation of the lift vector to produce a drag component in the direction of motion. This component is called the “induced drag”. The induced drag coefficient varies as the square of the lift coefficient because the amount of rotation and the magnitude of the lift vector increase simultaneously”. In the publication “Fundamentals of Aerodynamics by J. D. Anderson, it is disclosed that “induced drag (CDi) is a consequence of the presence of the wingtip vortices, which in turn are produced by the difference in pressure between the lower and upper wing surfaces (in an aircraft). The lift is produced by this same pressure difference. Hence, induced drag is intimately related to the production of lift on a finite wing; indeed, induced drag is frequently called the drag due to lift:

CDi=πb/2V∞S(C_{L}/πAR)2V∞SC_{L}/bπ

CDi=C_{L}²/πAR

Where C_{L}, is the lift coefficient, V is the true airspeed, AR is the aspect ratio, S is the gross wing area and L is the lift.

Clearly, an aeroplane cannot generate lift for free; the induced drag is the price for the generation of lift. The power required from an aircraft engine(s) to overcome the induced drag is simply the power required to generate the lift of the aircraft. Also, note that because CDi á C_{L}², the induced drag coefficient increases rapidly as C_{L} increases and becomes a substantial part of the total drag coefficient when C_{L} is high (e.g., when the aeroplane is flying slowly such as on take-off and landing). Even at relatively high cruising speeds, induced drag is typically 25 percent of the total drag”.

Also developed in aircraft is the use of (blended) winglets—a small aerofoil section member extending upwardly and outwardly from the tip of a wing. The purpose of these winglets is to control the flow of air from the higher pressure lower wing surface to the lower pressure upper wing surface and so reduce the formation of wingtip vortices, so reducing induced drag. It should be noted, however, that while such a blended winglet may provide some reduction in the induced drag created by wingtip vortices, it does not eliminate the trailing vortex wake which is in part created from the diverging/converging airflows at the wing trailing edge referred to above. It is a problem with such a winglet that, due to its reduced length, it is always of smaller length than the radius of the vortices produced at the wingtip, particularly when the aircraft is climbing at a higher angle of attack, rather than in straight and level flight in the cruise, when it produces a greater vortex diameter. The reduced length of the winglets is a mechanical restriction since they are manufactured to a specific length and designed for optimum performance at only one phase of flight, usually the cruise phase. Accordingly, such winglets do not give optimum performance throughout the flight envelope. Further, since such winglets are subject to dynamic and lateral flow forces, the winglet produces tension and/or torsion stresses in the associated wing section(s), so requiring strengthening of the wing/wing spar to avoid mechanical failure.

Dr Louis B Gratzer, Chief Aerodynamicist, API, Seattle, has stated that “It is intuitive that the smaller the winglet in comparison to the span of the wing, the less will be its effect. The rule of thumb for a winglet's height will be about 5 to 7 percent of the wing's span, but even then the small aerofoil's effectiveness cannot be assessed. The aerodynamic delivery is in the details”.

There have been various proposals for combating induced drag. In high performance sail planes and in long range airliners, high aspect ratio (AR) aerofoils are used (since, as shown above, induced drag is inversely proportional to aspect ratio). However, increasing the wingspan reduces manoeuvrability of the associated aircraft, as well as increasing airframe weight and manufacturing cost and profile drag. In addition, the design of high aspect ratio wings with sufficient structural strength is difficult.

LU-A-34999 discloses a dynamic airflow over an aerofoil section (see FIG. 4) entrained into slots connecting the upper and lower wing with the entrained air captured from the upper aerofoil section (the relatively low pressure side of the wing) and flowing downwardly and aft towards the lower aerofoil section (the relatively high pressure side of the wing). Given that the device is a passive wingtip blowing device, it is contrary to the laws of physics that air will flow from a region of low pressure to a region of high pressure. Further to this, the device simply addresses wingtip vortices, in that it proposes that wingtip blowing displaces and weakens the tip vortices, by weakening and displacing the circulatory air from the lower wing (the region of relatively high pressure) to the upper wing (the region of relatively lower pressure).

JP-A-04108095 discloses spanwise blowing over an aircraft wing due to mechanical means, for example jet engine bleed air. Spanwise blowing extends the effective span of the wing which displaces and weakens the tip vortices, but calculation of the magnitude of the effect is complicated by the fact that the issuing jet sheet will be rolled up by the pressure differential between upper and lower sides of the jet, eventually being swept into the tip vortices. This is an expensive modification to incorporate on a modern jet and while it may produce a slight reduction in induced drag (by artificially extending the effective span), the cost and weight and complexities of the design far outweigh any small performance improvements, not least that engine power (the thrust that propels the aircraft) taken to effectively “drive” the device.

US-A-2006/006290 discloses boundary layer control (BLC) and/or the use of small propellers or wind turbines on each tip. Extensive research has been carried out on BLC since the early post-war years. The severe engineering complexities of the design including the prohibitive cost make this design too unfeasible for aircraft usage.

US-A-2005/0184196 is similar to JP-A-0410895 in that it introduces spanwise blowing from a jet engine bleed air source. The device is stated to seek to “dissipate vortices that form at the wingtips on aircraft and from other airfoils”. In reality spanwise blowing extends the effective span of the wing which displaces and weakens the tip vortices, before being rolled up by the pressure differential between upper and lower sides of the jet. Therefore, whereas the device may reduce induced drag by a limited amount, the complexity and cost of incorporating it in aircraft, and the cost (in thrust terms) of utilising bleed air from an engine, far outweigh any advantages offered.

U.S. Pat. No. 5,806,807 discloses a semi-mechanical device aimed at reducing drag (see Abstract). A channel in the wing for directing air is fed with dynamic pressure from an air scoop. A scoop placed in the dynamic airflow will create form drag, as well as possible pressure drag (flow reversal) within the scoop. Mass flow and velocity depend on exit total/static pressure ratio and nozzle exit area. The flow control device within the channel serves no practical purpose, other than it could result in flow separation and pressure drag (reverse flow) and hence blockage of the airflow.

U.S. Pat. No. 5,158,251 discloses a mechanical device including a source of compressed fluid within the aircraft that is fed to the wingtip and discharged through a slot in a lateral direction to follow a downward vertical, or near vertical path providing a Coanda curtain to prevent crossflow of high pressure air around the wingtip to the upper low pressure wing area. It is more likely, given the pressure pattern existing at the wingtip, that the compressed fluid being discharged at the wingtip will follow, subject to pressure of the flow, a spanwise direction, and at best will therefore only displace the wingtip airflow spillage from high to low pressure, and as a result have a very limited effect on reducing induced drag. Indeed, the high cost of engineering this modification, and the use of (say) engine bleed air (as in JP-A-04108095) renders the device too complex in engineering weight and cost terms, thus any small performance improvement will be cancelled by the energy lost, if using engine bleed air, or any other system carried on the aircraft to provide the source of compressed fluid.

U.S. Pat. No. 4,478,380 utilises what is termed a NACA scoop. Given the design it is highly unlikely that dynamic airflow moving aft through the scoop and into the wingtip trailing edge area will have any effect on wingtip vortex formation given the latter prescribes a rotational path from the lower wing to the upper wing. This device also has a high degree of built-in drag and as such it might increase total drag at any given angle of attack.

U.S. Pat. No. 4,382,569 attempts to reduce induced drag via a series of mechanical devices using a pump system (or engine bleed air) to aspirate the crossflow captured by surface (10) (see Description of the Preferred Embodiments). Once again, and as with previous mechanical devices, this device is complex in its mechanical additions to any existing aircraft structure where weight and further drag incurred by weight, and cost of manufacture would negate any small gains made in attempting to reduce induced drag.

U.S. Pat. No. 4,040,578 discloses a mechanical device that seeks to diffuse (weaken) the undesirable blade tip vortices by blowing air from a fluid source, such as a compressor or a compressed air reservoir, in a downward jet flow. This disclosure follows the methodology of U.S. Pat. No. 4,478,380 and, as in that document, the engineering weight (and associated drag) and cost would negate any small gains theoretically claimed from the reduction in induced drag.

U.S. Pat. No. 2,163,655 utilises slots in the aircraft wing to “augment motion at the outer wingtips”. This statement made in the opening paragraph indicates that this device is seeking to increase induced drag. Another claim (lines 29 to 31) is that the air currents travelling through the slots “thus eliminating the down pressure and providing greatly increased stability and lift for the wingtips”; whereas the amount of air, if any, induced into the slots would be of a small amount and then exhausted along the surface, thus having no effect on down pressure.

According to a first aspect of the invention, there is provided a control device for mounting on a finite wing for generating lift in a fluid flow and having a first surface generating a relatively lower pressure in said flow and a second surface generating a relatively higher pressure in said flow, the first and second surfaces meeting at an end, the device including means that, when the device is mounted at said end, generate a fluid stream from fluid from said second surface so directed away from said second surface as to prevent or reduce the flow of fluid from the second surface to the first surface around said end.

Fluid air stream generated at the end of the aerofoil by the device according to the invention so prevents or reduces the formation of vortices at the end of the aerofoil. As a consequence, induced drag is reduced or eliminated.

Where the aerofoil is a wing, the spillage of air around the end of the aerofoil also distorts the air flow pattern over the upper surface of the aerofoil, so that, towards the end of the aerofoil, the air flow over the upper surface is pushed away from the end. This has the effect of producing additional vortices at the trailing edge of the aerofoil inboard of the end of the aerofoil, so adding to induced drag.

Preferably, in this case, the device includes attachment means having an aerofoil section, the attachment means being contiguous with the wing and producing over the upper surface thereof a pressure less than the pressure over the upper surface of the wing.

The presence of this lower pressure area on the attachment means it changes the airflow over the first surface of the aerofoil so that it mirrors the airflow over the second surface so reducing or eliminating the trailing edge vortices.

Whereas all previous attempts have been to reduce induced drag (total vortex generation as a by-product of lift), which persists inboard of the wingtip along the trailing edge (from the presence of diverging/converging airflows over the wing resulting in weaker vortices being shed from the trailing edge of the wing well inside the wingtip vortices outer limits of the horseshoe vortex); a device according to this aspect of the invention addresses the total induced drag problem in that it harnesses the negative energy created by induced drag, not only at the wingtip but inboard along the wing trailing edge, thus cancelling the effect of induced drag in its entirety.

The invention also includes within its scope a wing on which is mounted a device according to the first aspect of the invention.

The following is a more detailed description of some embodiments of the invention, by way of example, reference being made to the accompanying drawings in which:

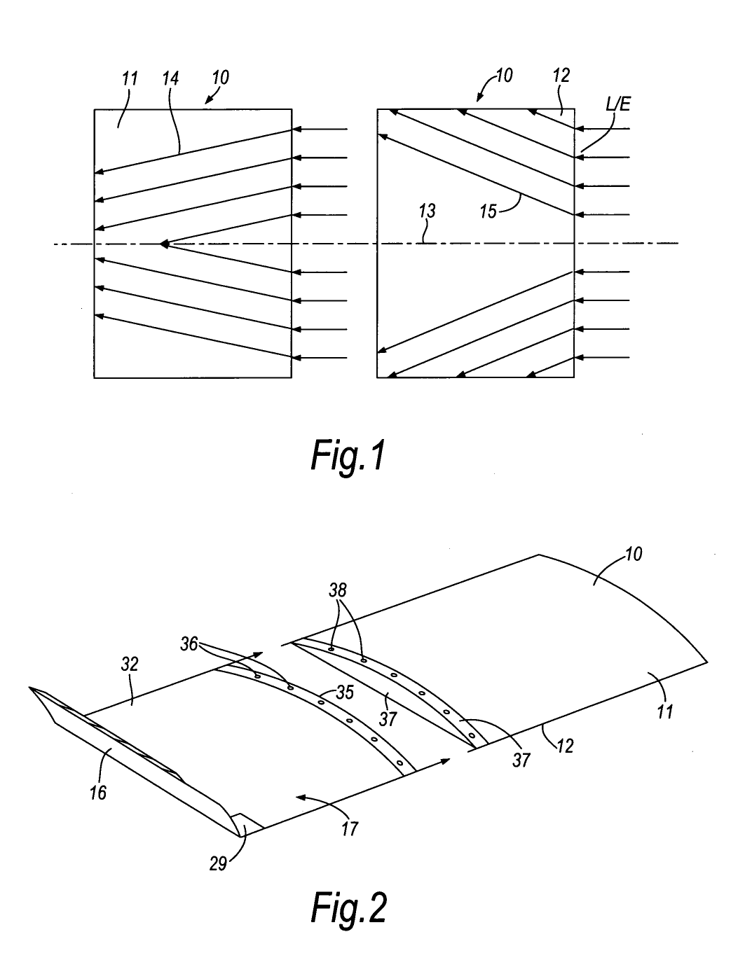

FIG. 1 is a schematic plan view from above (left) and below (right) of an aerofoil wing of an aircraft showing schematically the flow of air over the wing,

FIG. 2 is a schematic perspective view of an end of a wing of an aircraft, and showing the fitting to an end of a wing of a control device for producing an air jet to block and entrain airflow spillage from a lower surface of the wing to an upper surface of the wing,

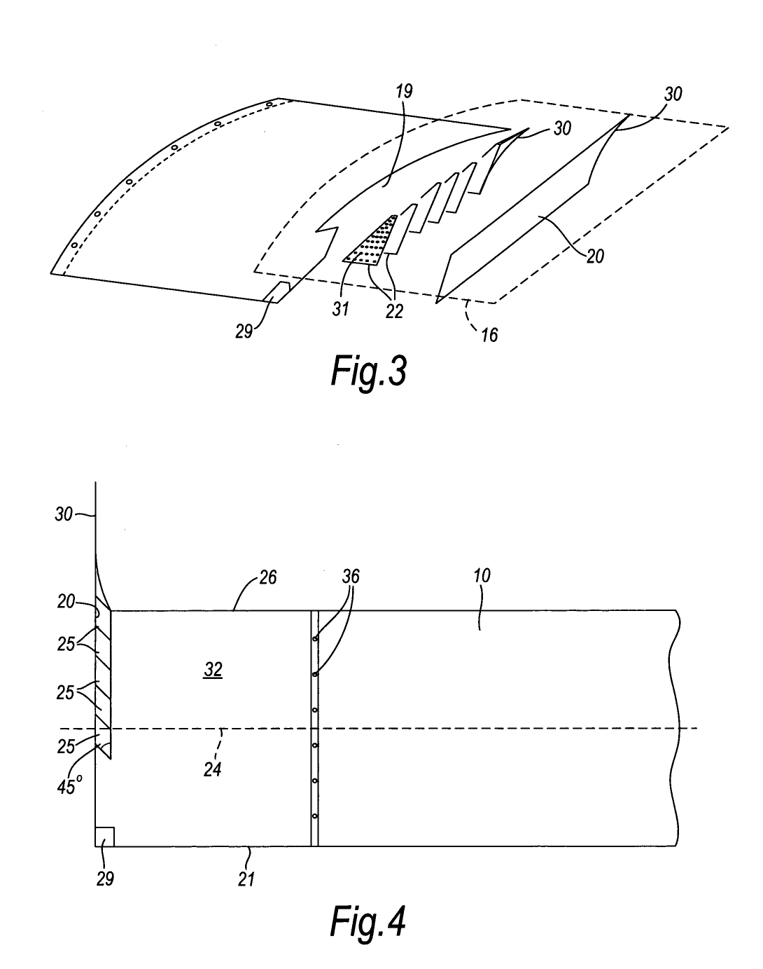

FIG. 3 is a schematic view of the device of FIG. 2, showing the internal construction of the device,

FIG. 4 is a plan view from above of the device of FIGS. 2 and 3, fitted to the starboard wing of an aircraft, the wing being of the kind shown in FIG. 2,

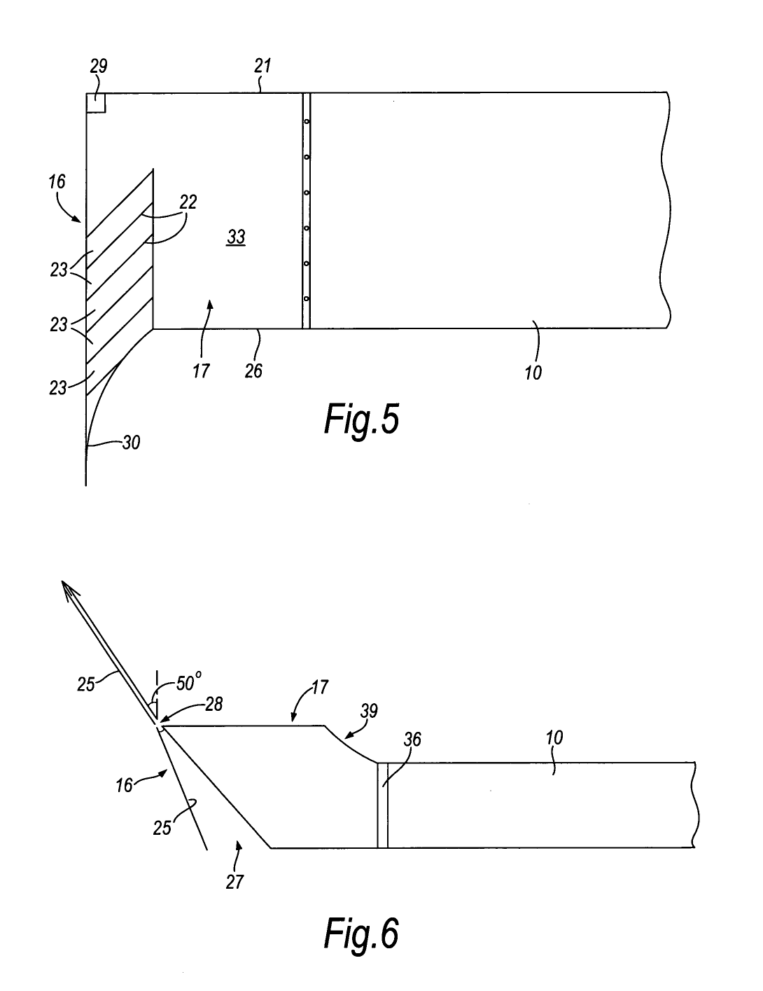

FIG. 5 is schematic underneath plan view of the device and wing of FIG. 4,

FIG. 6 is a schematic view of the device and the wing of FIGS. 2 to 5 showing the device in section and the angle of an air jet exiting the device and showing also a portion of the device of increased camber,

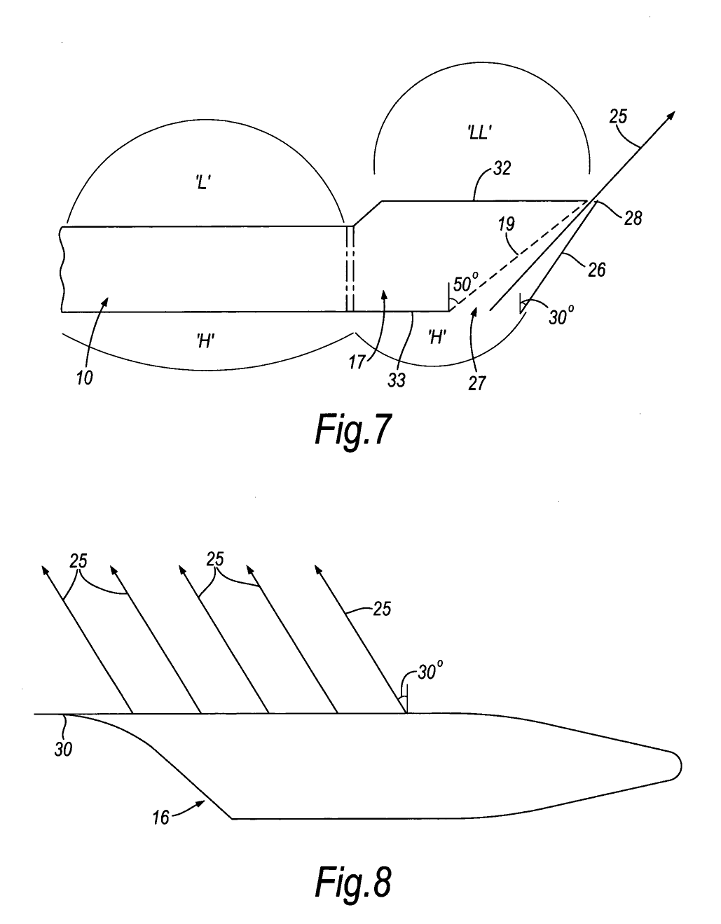

FIG. 7 is a similar view to FIG. 6 showing the pressure distribution across the end of the wing relative to the pressure distribution across the device,

FIG. 8 is an end elevation of the device showing the angle of the air jet,

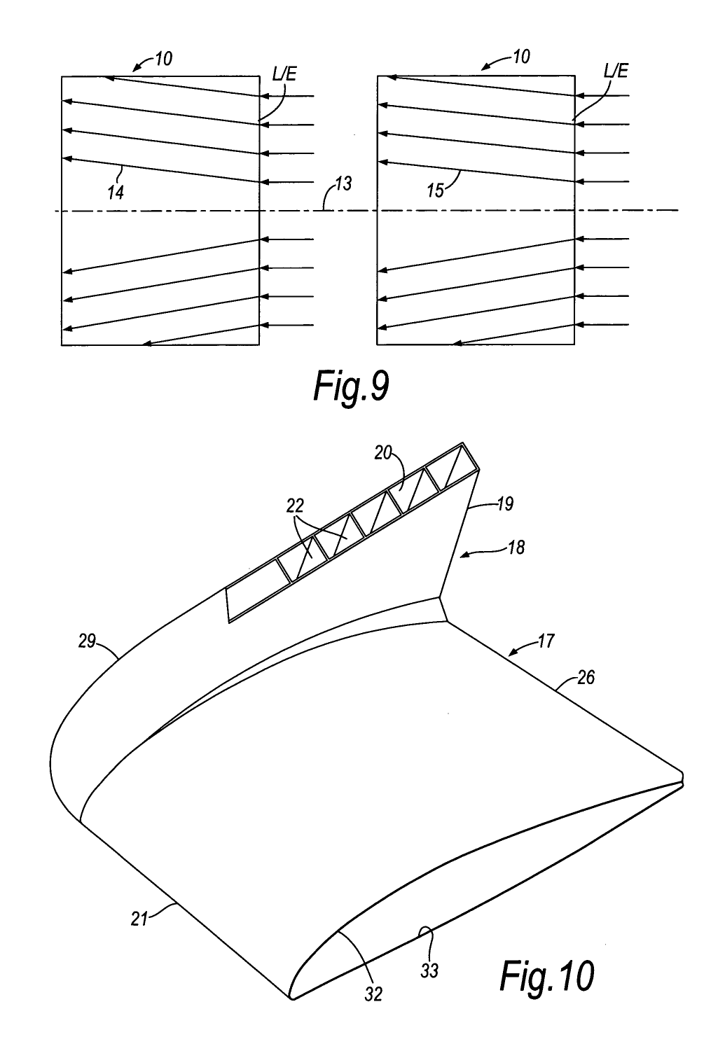

FIG. 9 is a plan view from above (left) and below (right) of a wing fitted with the device and showing the airflow over the wing turned by the increased camber of the device,

FIG. 10 is a perspective view from above, the front and to one side of a second form of control device,

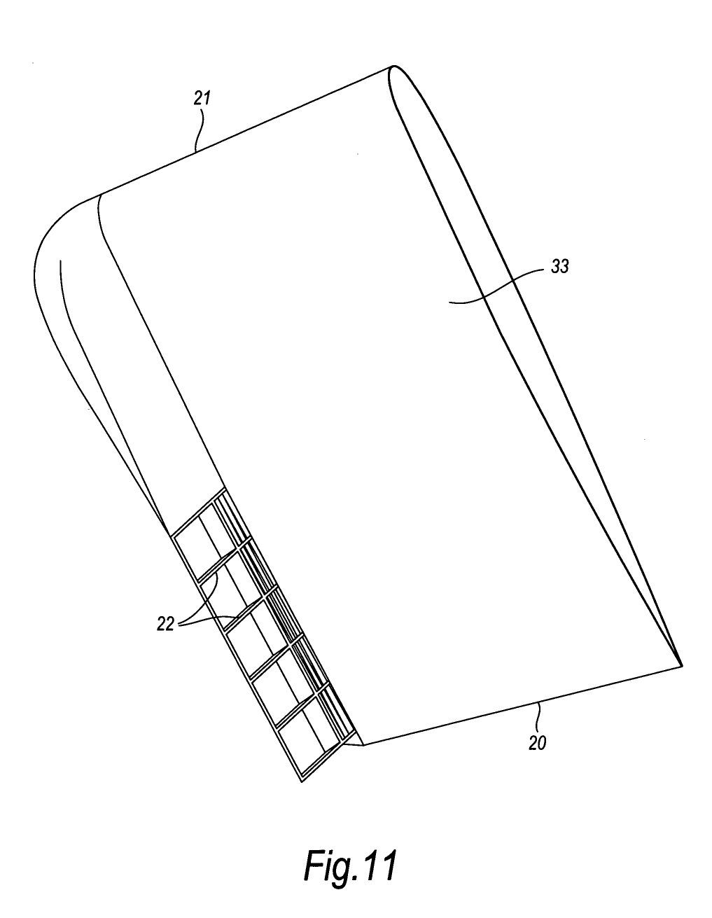

FIG. 11 is a perspective view from below, the rear and to one side of the control device of FIG. 10, and

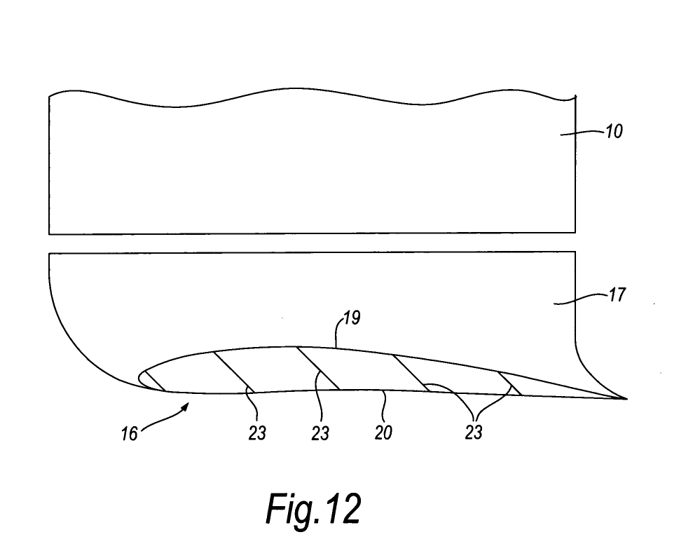

FIG. 12 is a plan view from above of an end of a wing carrying an alternative embodiment of the control device.

Referring first to FIG. 1, the wing 10 shown diagrammatically has an upper surface 11 and a lower surface 12. The wing 10 is disposed to either side of a fuselage (not shown) but indicated by a centre line 13. The wing 10 has an aerofoil section.

As is well known, when the wing 10 is in motion, the airflow over and under the wing 10 produces a relatively lower pressure over the upper surface 11 of the wing 10 and a relatively higher pressure over the lower surface 12 of the wing 10. As a result of this pressure difference, air from the higher pressure region on the lower wing surface 12 tends to seek the lower pressure area on the upper surface 11. The streamlines 14 on the upper surface 11 thus tend to converge towards the fuselage centre line 13 while the streamlines 15 on the lower surface 12 tend to diverge from the fuselage centre line 13, as shown in FIG. 1. The convergent flow on the upper surface 11 and the divergent flow on the lower surface 12 produce vortices that are shed from the trailing edge of the wing 11 inboard of the end of the wing 10.

This spillage of air from the lower wing surface 12 to the upper wing surface 11 sets up a vortex and these vortices together with the trailing edge vortices describe a “horseshoe” shaped vortex sheet behind the wing 10 of up to 16 times the length of the wingspan. The effect of this airflow is to generate an induced drag that is inversely proportional to the square of the airspeed and inversely proportional to the aspect ratio.

Referring now to FIGS. 2, 3, 4 and 5, a control device for fitting to the wing 10 comprises an airbox assembly indicated generally at 16 carried at one end of a wingtip 17 having an upper surface 32 and a lower surface 33.

The airbox assembly 16 comprises a housing 18 that may, for example, be formed of a plastics material. The housing 18 includes an inboard wall 19 and a spaced outboard wall 20. The inboard wall 19 and the outboard wall 20 are each generally rectangular in side elevation (although concave in the direction of the fuselage). As seen in FIG. 6, the inboard wall 19 and the outboard wall 20 converge towards each other in an upward and rearward direction. The inboard wall 19 and the outboard wall 20 are spaced apart by six frustro-triangular vanes 22. The vanes 22 are arranged parallel to one another but spaced so that the vanes 22 form between them five parallel passages 23 extending from the lower surface 33 to the upper surface 32 and converging from the lower surface 33 to the upper surface 32. The convergence may be at least 3:1 and is preferably 4:1.

As seen in FIG. 4, the vanes 22 are inclined at an angle to a plane including the wing axis 24 and normal to the plane of the wing tip 17. This angle may be between 30° and 70° and is preferably 60°. The angle may vary from vane to vane. In addition, as seen in FIG. 6, the axis 25 of the each passage 23 is inclined outwardly relative to a plane normal to the wing axis 24 and normal to the plane of the wing 10. This inclination may be between 30° and 70° and is preferably 50°. Further, as seen in FIG. 8, each passage axis 25 is also inclined relative to a plane including in the wing axis 24 and normal to the plane of wing 10. This inclination may be between 20° and 50° and is preferably 30°. As seen particularly in FIG. 5, the length of the passages 23 is the same between successive passages 23 from the leading edge 21 of the wing to the trailing edge 26. As a result of this configuration, each passage 23 has an inlet 27 that is closer to the leading edge 21 than the associated outlet 28.

The forward part of the housing 18 may contain navigation lights 29. In addition, the trailing edge of the housing 18 may be provided with a stinger fairing 30 extending beyond the trailing edge 26. This stinger fairing 30 may house a static wick for airframe electrical discharge.

The wing tip 17 is of aerofoil shape with the upper surface 32 and the lower surface 33 extending between a leading edge 21 and a trailing edge 26. The airbox assembly 16 is mounted at one end of the wing tip 17 and the other end is provided with an open end 35 that, in use, is a mating fit with an open end of the wing 10 to be described in more detail below. The profile of the wing tip 17 is matched to the profile of the associated wing. This will also be described in more detail below.

As seen in FIGS. 3 and 4, the lower surface 33 of the wing tip 17 leads to the inlets 27 to the passages 23. In order to prevent separation of air from these surfaces, they may be covered with trip strips or other means for inducing turbulence in the boundary layer. These are desirable because, whereas at low Reynolds numbers (Re), the boundary layer of this airflow entering the airbox will remain attached to the surface, as Re increases the boundary layer can separate causing turbulence and (possible) flow reversal (pressure blockage). Depending upon the aerofoil sections in question and therefore the radii of inlets employed in the airbox inlet, a trip strip has the effect under higher Re and leading edge radii of keeping the airflow attached to the radii in question and thus, in effect rendering the airbox free of pressure blockage through varying Re.

In use, the device is fitted to the outboard end of the wing 10 of an aircraft. As seen in FIG. 2, the outboard end of the wing 10 is provided with a peripheral recess 37 around the cross-section of the wing 10 formed with fixing holes 38. The open end 35 of the wing tip 17 fits over the recess 37 with the fixing holes 36 in the wing tip 17 aligned with the fixing holes 38 around the recess. Fixing means such as screws or rivets are then used to connect the parts together.

In relation to the wing 10, the wing tip 17 is provided with an aerofoil section that has an improved lift/drag ratio. For example, if the wing 10 is a NACA 2412 aerofoil, the wingtip 17 may be a NACA 4412 aerofoil, or, if the wing 10 is a NACA 4415 aerofoil, the wingtip 17 may be a NACA 6415 aerofoil. The effect of this is that the wing tip 17 has a slightly increased camber, relative to the wing 10. The result of this, as seen in FIG. 7, is to produce over the upper surface 32 of the wing tip 17 an area of pressure that is lower than the pressure over the upper surface 11 of the wing 10. Accordingly, as seen in FIG. 6, the wing tip 17 has a zone 39 in which the profile of the wing tip 17 blends into the profile of the wing 10.

In flight, as described above, the aerofoil section of the wing 10 produces a greater pressure on the lower wing surface 12 than on the upper wing surface 11 and the airflow over the lower surface 12 tends to migrate towards the lower pressure area on the upper surface 11 in an outward flow of the kind shown in FIG. 1. This air will enter the inlets 27; being held to the lower surface 33 of the wing tip 17 by the trip strip or other turbulence inducing formations provided on the lower surface 33 of the wing tip 17. The angling of the inlets 27 as seen in FIG. 5 encourages this flow. The air enters the passages 23 and is accelerated as the passages 23 converge. There thus emerges from the outlets 28 five jets of air that form a sheet or wall of fast moving air. As a result of the orientation of the passages 23, this sheet of air is directed upwardly, outwardly and rearwardly of the wing tip 17.

The airflow through the passages 23 weakens the general spillage of air around the wing tip 17 from the lower surface 12 of the wing 10 to the upper surface 11 of the wing, since some of the air passes through the passages 23 to form the air stream emerging from the outlets 28. Such air as does pass around the end of the wing tip 17 will merge with the sheet of air emerging from the outlets 28 to produce a cumulative rearwardly directed but non-vortex containing airflow. In this way, the induced drag that would be created by such vortices in the absence of the device, is considerably reduced or eliminated.

In addition, the aerofoil section given to the wing tip 17 produces at the wing tip 17 an area of pressure that is lower than the pressure on the upper surface 11 of the wing 10. This is seen in FIG. 7. The affect of this is to change (or turn) the airflow over the upper surface 11 of the wing from that shown in FIG. 1 to that shown in FIG. 9. As seen in that figure, the airflow over the upper surface 11 of the wing 10 is now away from the centre-line 13. In addition, the flow over the lower surface 12 of the wing 10 is less markedly outwardly directed than in the absence of the device and corresponds to the airflow over the upper surface 11 of the wing 10. Accordingly, the airflow over both surfaces is substantially the same (i.e. the direction of flow of air over the upper surface 11 is in the same direction as the flow of air over the lower surface 12 at corresponding sections along the wing 10 and the wing tip 17), thus cancelling the vortex sheet that normally emanates from the trailing edge 26. A report on a device according to an embodiment of the invention states “Reducing the strength of the wingtip vortices, diffusing them, and displacing them outboard will reduce the downwash on the wing at a given angle of attack, thereby resulting in an increase in lift and a decrease in induced drag. Experiments have shown that spanwise blowing from the wingtip displaces and diffuses the wingtip vortex. Span wise wingtip blowing thus has the potential to improve the wing aerodynamic efficiency”.

It will be appreciated that the sheet or jet of air emerging from the outlet 28 will have a velocity related to the velocity of the air over the wing 10 and the wing tip 17. Accordingly, the velocity and length of the sheet of air will automatically vary in accordance with changes in the angle of attack and true airspeed of the wing 10. Thus, at higher airspeeds, the velocity and length of the sheet or jet of air will be greater when the pressure differentials between the upper and lower surfaces 11, 12 of the wing 10 are greatest. These varying pressure differentials thus effectively “tune” the device to provide a sheet or jet of air of optimum length during different phases of flight.

In this regard, it is known that the mean diameter of the vortex at a wing tip is approximately 0.171 of the wingspan for a given aircraft. It has been found that, during flight testing of an embodiment of this device, the length of the air sheet or jet produced by the device exceeds this by a factor of 1.5 at any given angle of attack.

The air emerging from the passages 23 produces a downward resultant force that is equal to the lift produced by the wing tip 17. There is thus no torsional or tension stress on the device and its attachment points. This is why the device can be a sleeve fit onto the wing 10 and attached by machine screws. No additional wing spar attachment strengthening is required both as a result of this and because the device can be manufactured from a lightweight material, such as a carbon fibre composite material, to match the weight and centre of gravity of the wing tip it replaces. A device as the kind described above with reference to the drawings for use on a general aviation aircraft might, for example, weigh between 2 kg and 4 kg.

Referring next to FIGS. 10 and 11, the second control device has many parts in common with the device of FIGS. 1 to 9. Those parts are given the same reference numerals in FIGS. 10 and 11 as in FIGS. 1 to 9 and are not described in detail.

In the embodiment of FIGS. 10 and 11, the stinger 30 is omitted.

A device of the kind described above with reference to the drawings and made from glass-fibre has been fitted to a Cessna 172 aircraft. Flight trials were conducted under EASA/CAA approval in clear air over a number of routes at altitudes of up to 2438 meters (8000 ft). In all cases the test flights were measured against the identical profile flown by the same aircraft without the device. The modified aircraft flew the same test profiles with an average 7.75% improvement in performance and fuel burn. It is expected that future forms of the device will achieve improvements of greater than 10%.

It is believed that aircraft fitted with the device will, therefore, have reduced fuel consumption with correspondingly reduced carbon emissions. There will be lower airport noise levels from a reduced dBA footprint at take-off. In addition, the absence of induced drag will provide a boost in climb performance, higher cruise altitude and higher cruise speed. There will also be the removal of hazardous wake vortices that can cause problems on take-off and landing for an aircraft following another aircraft that has just taken off or landed. The device will also provide lower stall speeds, lower take-off speeds and lower target threshold speeds on landing with consequent lower touch-down speeds. This will reduce runway extension requirements, allowing operations from existing shorter runways. As a result, there will be reduced maintenance costs with normal check cycles being extended and there will also be less wear on tyres and brakes and thrust reversal equipment. In view of the decreased fuel consumption, less fuel will need to be uplifted for any given trip thus allowing the payload to be increased (subject to zero fuel weight requirements not being exceeded). Further, the device is simple and relatively inexpensive to construct and equally simple and inexpensive to fit.

It will be appreciated that there are a large number of modifications that can be made to the device described above with reference for the drawings. For example, there need not be five passages 23; there could be any suitable number. In addition, the convergence of the passages 23 can be varied as required as can the angle at which the air stream emerges. The air stream may need not be derived wholly or even partially from the lower surface 12 of the wing 10; bleed air from the engine or engines could be used either wholly or partially to provide the air stream. Any other source of air could be used.

The passages 23 need not be of the same length; they could be of differing lengths. In addition, the passages 23 need not be parallel to one another; they could have centre lines that converge in an upward direction or diverge.

An alternative construction of the airbox is shown in FIG. 12. Parts common to this Figure and to FIGS. 1 to 11 are given the same reference numerals and will not be described in detail.

Referring to FIG. 12, the wing 10 has the NACA 2412 aerofoil section described above with reference to FIGS. 1 to 7 and the wingtip 17 has the NACA 4412 aerofoil section. In this embodiment, however, the inboard wall 19 and the outboard wall 20 of the airbox 16 are shaped to provide an exhaust that has a profile that is a scaled-down profile of the wingtip 17. In this case, therefore, the exhaust has a profile that is a scaled-down profile of an NACA 4412 aerofoil.

The effect of this is to match the air speed through the airbox to the air-speed profile over the lower surface 12 of the wing 10. The air passing over the lower surface 12 of the wing 10 will, as explained above, tend to seek the lower pressure area on the upper surface giving a streamline profile as seen in FIG. 1. The volume of air travelling to the inlets 27 will have a profile that matches the wing profile with a greater volume at the upstream and central inlets 27 and lesser volumes at the downstream end. The effect of the shaped exhaust is to provide converging passages 23 that are, at the downstream end of the exhaust of smaller cross-sectional area than those at the upstream and centre. In this way, air entering the downstream passages is accelerated by these passages 23 to a greater extent than the air passing through the central passages 23. As a result, these lower volumes of air nevertheless maintain the length of the air sheet or jet produced by the device over the length of the wing 10 from the leading end to the trailing end.

Of course, the exhaust profile need not be precisely the same profile as the wingtip 17. Other profiles could be used.

It is also possible to provide serrated leading edges on the airbox vanes 23 (and associated leading edges within the airbox that produce noise) to reduce or cancel noise from these edges.

In the device described above with reference to the drawings, the jet box assembly 16 and the profile wing tip 17 are used together. The essence of the device described above with reference to the drawings is that it generates a fluid stream directed away from the wing to reduce or eliminate induced drag.

It will also be appreciated that a device of the kind described above with reference to the drawings may be used with aerofoils other than wings. Such a device may be used on aerofoils such as propeller blades or, for example, wind turbines. It may be used on aerofoil sections found on motor vehicles such as racing cars. In addition, it may be used with fluids other than air—for example water, where it may be used on hydrofoils and other foils where a force is produced as a result of the foil traveling through fluid.

1. A control device for mounting on a finite wing for generating lift in a fluid flow and having a first surface generating a relatively lower pressure in said flow and a second surface generating a relatively higher pressure in said flow, the first and second surfaces meeting at an end, the device including means that, when the device is mounted at said end, generates a fluid stream from fluid from said second surface so directed away from said second surface as to prevent or reduce the flow of fluid from the second surface to the first surface around said end.

2. A control device according to claim 1 wherein said means comprise at least one passage extending from said second surface, air from said second surface entering said at least one passage and exiting the at least one passage to form said fluid stream.

3. A control device according to claim 2 wherein the at least one passage is convergent in the direction of flow of fluid through to the passage.

4. A control device according to claim 3 wherein the ratio of the cross-section of the at least one passage at a downstream end thereof to the cross-section of the at least one passage at the upstream end thereof is at least 3:1.

5. A control device according to claim 4 wherein five passages are provided extending side-by-side in a direction from a leading edge of said wing to a trailing edge of said wing.

6. A control device according to claim 2 wherein said passages are provided in a housing.

7. A control device according to claim 6 wherein said housing has an outer wall formed with a concave outer surface for deflecting air away from the wing.

8. A control device according to claim 1 and including attachment means for attaching the device to an end of a wing.

9. A control device according to claim 8 wherein the attachment means include a surface leading to an inlet of the or each passage, air from said surface passing to said inlet before entering said at least one passage.

10. A control device according to claim 9 wherein the attachment surface, adjacent the or each said inlet, is provided with formations for holding the airflow to the inlet attached to the surface so preventing or reducing separation of said airflow.

11. A control device according to claim 10 wherein said formations comprise at least one trip strip.

12. A control device according to claim 8 wherein the attachment means include an aerofoil section for connection to an end of a wing and having a first surface generating a relatively lower pressure in said flow and a second surface generating a relatively higher pressure in said flow, the first surface of the attachment means being, in use, contiguous with the first surface of the wing and the second surface of the attachment being, in use, contiguous with the second surface of the wing.

13. A control device according to claim 12 wherein the aerofoil section of the attachment means has a profile such that air flowing over said first surface of the aerofoil section of the attachment means produces a zone having a pressure that is lower than the pressure over the first surface of the wing in said air flow.

14. A control device according to claim 13 wherein the profile of the aerofoil section of the attachment means is such as to modify the airflow over the upper and lower surfaces of the wing so that the respective flows are generally directionally parallel so avoiding the formation of a vortex sheet at the trailing edge of the wing.

15. A control device according to claim 13 wherein the first surface of the aerofoil section includes formations for preventing separation of fluid flow from the aerofoil section as said fluid flow passes to the inlet.

16. A control device according to claim 13 wherein said passages are provided in a housing and wherein the housing extends from the section of maximum camber of the aerofoil section of the attachment means towards a trailing edge of said section.

17. A device according to claim 13 wherein the passages are provided in a housing and wherein the housing has a cross-section that is a scaled version to the cross-section of the aerofoil section of the attachment means.

18. A control device according to claim 1 wherein said means is 10 such that the fluid stream is directed outwardly at an angle of between 30° and 70° to a plane normal to the plane of the wing and normal to the length of the wing.

19. A control device according to claim 18 wherein the angle is 50°.

20. A control device according to claim 1 wherein the said means is such that fluid stream is directed at an angle of between 20° and 50° to a plane including the length of the wing and normal to the plane of the wing.

21. A control device according to claim 20 wherein the angle is 30°.

22. A control device according to claim 1 wherein said means produce a fluid stream having an effective length at least 1.5 times the maximum diameter of vortices generated at said end in the absence of the device.

23. A control device according to claim 1 wherein the device includes at least one member having a leading edge, said leading edge including a plurality of notches for reducing noise generated by fluid passing over said leading edge.

24. A wing of an aircraft having an outboard end, a control device according to claim 1 being connected to said outboard end.

25. A wing according to claim 24 wherein the device includes attachment means having an aerofoil section, the attachment means being contiguous with the wing and producing over the upper surface thereof a pressure less than the pressure over the upper surface of the wing.

26. A wing according to claim 25 wherein the NACA number of the aerofoil section attachment means is greater than the NACA number of the wing.

27. An aircraft wing for generating lift in an airflow comprising a root portion for connection to body of the aircraft, a central span and a wing tip, the wing having an upper surface for generating a relatively lower pressure in said flow and a lower surface for generating a relatively higher pressure in said flow, the wing tip carrying at an outer most end thereof a control device having an inlet for receiving air from said lower surface and including means for directing said air in a sheet rearwardly, upwardly and outwardly of said wing to prevent the flow of air from said lower surface to said upper surface as air flows over said surfaces.

28. A wing according to claim 27 wherein the wing tip includes, adjacent said control device, a portion of said upper surface that generates, in said airflow, an area of pressure that is lower than the pressure generated over the upper surface of the central span to in said airflow such that the airflow over the upper surface of the wing is directionally generally the same as the airflow over the lower surface to reduce or prevent the formation at the trailing edge of the wing of trailing edge vortices.

29. A wing according to claim 27 wherein wing includes attachment means having an aerofoil section, the attachment means being contiguous with the wing and producing over the upper surface thereof a pressure less than the pressure over the upper surface of the wing, and wherein the NACA number of the aerofoil section attachment means is greater than the NACA number of the wing.

30. An aircraft including a control device according to claim 1.

31. A method of preventing or mitigating the formation of wing-tip vortices in aircraft comprising forming, from air travelling over an under surface of the wing, a sheet of air extending upwardly, outwardly and rearwardly of the tip of the wing.

32. A method of preventing or mitigating the formation of trailing edge vortices on a wing of aircraft comprising re-configuring the flow of air over an upper surface of the wing so that the direction of flow of said air over said upper surface mirrors the direction of flow of air over a lower surface of the wing.

33. An aircraft including a wing according to claim 24.
